(19) United States
(12) Patent Application Publication
(10) Pub. No.: US 2012/0213948 A1
(43) Pub. Date: Aug. 23, 2012

(54) LOCALIZED MICROWAVE SYSTEM AND METHOD

(75) Inventors: Jeffrey Jon Schoonover, Albany, NY (US); Mahesh Chandran, Bangalore (IN); Sarah Lillian Katz, Albany, NY (US); Laurent Cretegny, Niskayuna, NY (US); Drew Brisco, Latham, NY (US); David John Smith, Clifton Park, NY (US); Vasile Bogdan Neculaes, Niskayuna, NY (US)

(73) Assignee: GENERAL ELECTRIC COMPANY, Schenectady, NY (US)

(21) Appl. No.: 13/400,278

(22) Filed: Feb. 20, 2012

Related U.S. Application Data
(60) Provisional application No. 61/445,335, filed on Feb. 22, 2011.

(51) Int. Cl. B05D 7/00; H05B 6/64; B05C 5/04

(52) U.S. Cl. 427/575; 118/620; 118/50.1; 219/678

(57) ABSTRACT

A system for repairing a crack in a component, or forming a joint between two components, is described. The system includes a filler material; a plasma-generating material; and a ceramic cover that is positioned around the crack, or around an interface region between two components that are to be joined. The filler material is positioned proximate to the crack or the interface region; and the plasma generating material is positioned in the vicinity of the crack or the interface region. A microwave generator for generating a microwave field inside an enclosure region enclosed by the cover, and proximate to the crack or interface region, also forms part of the system. Related methods for filling at least one cavity in a casting component are also described.

### CROSS-REFERENCE TO RELATED PATENT APPLICATIONS

This application claims priority to U.S. provisional patent application Ser. No. 61/445,335, filed Feb. 22, 2011, which is hereby incorporated by reference in its entirety.

### STATEMENT REGARDING FEDERALLY SPONSORED RESEARCH & DEVELOPMENT

This invention was made with Government support under contract number DE-EE0003464,awarded by the Department of Energy. The Government has certain rights in the invention.

### TECHNICAL FIELD

The present invention relates generally to the repair of high-temperature, nickel superalloy components, and more specifically to a localized heating method and system for repairing high-temperature, nickel superalloy components. Embodiments are also directed to related techniques for joining metal components.

### BACKGROUND OF THE INVENTION

Superalloys are often the materials of choice for components intended for high-temperature environments. For example, gas turbines and steam turbines often contain parts formed from single-crystal castings of nickel superalloys. (The term “superalloy” is usually intended to embrace complex cobalt- or nickel-based alloys).

During use in such high temperatures, components often develop cracks or other flaws. Replacement costs for the superalloy components are expensive. Thus, when possible, repair is the preferable option over replacement. However, the repair of high-melting, single crystal castings of superalloys can be challenging.

Reference is made to FIG. 1, where a component 10 of a gas turbine is shown. The component may be any single crystal casting component formed of a superalloy, and found within gas turbines. Non-limiting examples of such components 10 include sections of jet engines and gas turbines such as turbine buckets, blades and vanes. Through use, such components, like component 10, may develop one or more cracks 12 located therein.

Heating the part is an essential step in the repair process for a crack such as that depicted in the figure. In general, there are two primary advantages to heating only the area to be joined or filled, rather than heating the entire component. The first is that it enables the repair of single crystal components. In most cases, these cannot be repaired with conventional brazing techniques. This is due in part to the fact that, in a standard vacuum braze furnace, the component and braze alloy both reach the braze temperature. In the case of repairs to high-temperature/high-strength components like those made from superalloys, the braze temperature is usually above the recrystallization temperature, resulting in the loss of the single crystal structure that would usually need to be retained in the components after those types of repairs.

The second advantage stems from that fact that the localized heating improves the mechanical properties of the joint, by allowing the removal of melting point suppressants from conventional braze alloys. (The presence of these suppressants in the braze alloys, in lowering the melting point of the original single crystal casting, can sometimes result in a repaired crack or joint that is thermally weaker than the remainder of the component, and that can exhibit reduced mechanical strength).

Welding is another metal-joining technology where heat is locally applied to form a joint. However, welding is not typically used for these high temperature, high performance applications. Drawbacks of welding techniques in these situations include the lack of temperature control, and the creation of residual stress that can lead to hot cracking and significant deformation.

Microwave-based joining techniques have three key advantages over welding, for very high temperature, high performance applications. The first advantage is uniform heating of the entire joint area. This reduces residual stress and is achieved by heating a microwave susceptor that uniformly covers the joint area. The second advantage is that the process is stationary, so complicated robotics and vision systems are not required. The third advantage is that microwave joining is usually carried out in a vacuum chamber, allowing better atmosphere control for more consistent metallurgical results.

The local heating techniques discussed above, using a microwave field generated in the vicinity of a crack in a turbine component, have been described in the patent literature. As an example, Cretegny et al., U.S. Pat. Pub. 2010/0193574 (hereinafter “Cretegny et al”), describes the use of a plasma generator material, positioned near a filler material. Upon the generation of a microwave field, the microwave field heats and vaporizes the plasma generator material, and then ignites a plasma with the vapor. The heat from the plasma then melts the filler material. While the technology described in Cretegny et al is very useful in some end use applications, there may be drawbacks in other end use applications. As an example, it may sometimes be difficult to obtain the very high plasma temperatures required for melting superalloy filler materials.

Another known heating technique utilizing microwaves is described in U.S. Pat. No. 6,870,124 (Kumar et al), and includes a plasma generating material that is gaseous at room temperature. Such a technique usually requires the use of a vacuum chamber that incorporates a line or conduit to input the plasma generating material. In this technique, the entire component is placed within the vacuum chamber. Thus, the entire component is subjected to the heating regime; and this can be disadvantageous in some instances.

In some types of localized heating techniques, a plasma-supply line usually must be positioned to supply the gaseous plasma generating material to a location very near the crack and the filler material. However, siting the line such that it points directly at the crack essentially creates a plasma torch for local heating. Plasma torches, which can be readily formed in other ways, are sometimes not particularly advantageous in microwave applications directed to high-temperature/high-strength components. Moreover, these techniques may require that the vacuum chamber and the input line be specially designed and set up for each new crack being repaired.

From this discussion, it should be apparent that new systems and techniques for joining or repairing single crystal casting components (e.g., using superalloy materials) would be welcome in the art. The new techniques should address at least some of the disadvantages described above, inherent in previous processes.

### SUMMARY OF THE INVENTION

One embodiment of the invention is directed to a system for repairing a crack in a component, or forming a joint between two components, wherein the system comprises:

a) filler material;

b) a plasma-generating material; and

c) a ceramic cover, wherein
the cover is positioned around the crack or around an interface region between two components that are to be joined;
the filler material is positioned proximate the crack or the interface region; and
the plasma generating material is positioned in the vicinity of the crack or the interface region; and

d) a microwave generator for generating a microwave field inside an enclosure region enclosed by the cover, and proximate to the crack or interface region.

Another embodiment of the invention relates to a method for filling at least one cavity in a metallic component (e.g., a single-crystal casting component), comprising the steps of:

(i) disposing a filler material proximate to the cavity;

(ii) situating a plasma-generating material in the vicinity of the cavity;

(iii) providing a ceramic cover over the cavity in the component, so as to form an enclosure region under the cover; and

(iv) generating a microwave field within the enclosure region that provides microwave energy to ignite and sustain a plasma, wherein the plasma pre-heats the filler material; and wherein the microwave energy is absorbed by the cover to increase the cover temperature, thereby completely melting the filler material, and causing it to flow into the cavity. A similar process can be used to form or repair a joint, as described below.

An additional embodiment set forth herein is directed to a method of refurbishing a turbine engine, comprising the following steps:

(I) identifying a crack or joint in a component of the turbine engine;

(II) situating a filler material proximate to the crack or joint;

(III) disposing a plasma-generating material in the vicinity of the crack or joint, separate from the filler material or combined therewith;

(IV) enclosing the crack or joint and filler material within a ceramic cover; and

(V) exposing the cover to a microwave field, wherein the microwave field ignites and sustains a plasma for preheating the filler material and the cover; and wherein microwave energy absorbed by the cover melts the filler material into the crack or joint.

### BRIEF DESCRIPTION OF THE DRAWINGS

FIG. 1 is a cross-sectional view illustrating, schematically, a crack within a single crystal casting component.

FIG. 2 schematically illustrates a system for repairing a crack within a single crystal casting component in accordance with an embodiment of the invention.

FIG. 3 illustrates a repaired crack using the system of FIG. 2, in accordance with an embodiment of the invention.

FIG. 4 schematically illustrates a system for repairing a crack within a single crystal casting component in accordance with another embodiment of the invention.

FIG. 5 illustrates steps for repairing a crack in a single crystal casting component in accordance with one embodiment of the invention.

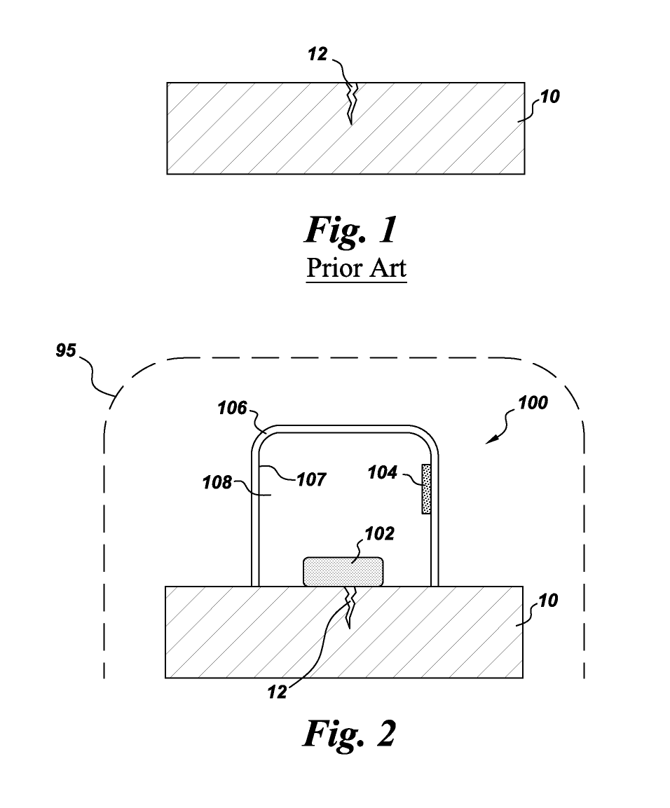

### DETAILED DESCRIPTION OF THE INVENTION

In the following description, specific details are set forth such as specific quantities, sizes, and the like, so as to provide a thorough understanding of embodiments of the invention. However, it will be obvious to those skilled in the art that the invention may be practiced without such specific details. In many cases, details concerning such considerations and the like have been omitted, inasmuch as such details are not necessary to obtain a complete understanding of the invention, and are within the skills of persons of ordinary skill in the relevant art.

Referring to the drawings in general, it will be understood that the illustrations are for the purpose of describing a particular embodiment of the invention, and are not intended to limit the invention thereto.

While most of the terms used herein will be recognizable to those of skill in the art, the following definitions are nevertheless put forth to aid in the understanding of the present invention. It should be understood, however, that when not explicitly defined, terms should be interpreted as adopting a meaning presently accepted by those of skill in the art.

Referring to FIG. 2, there is shown a repair system 100 in accordance with an embodiment of the invention. (As described further below, the term “repair” is used herein for simplicity, but is also meant to describe various filling processes, as well as processes for joining two components together, or for repairing, e.g., “patching”, a joint previously formed between two components). The system 100 includes the placement of a filler material 102 in the vicinity of the crack 12. Instead of a crack 12, the system 100 can be sited over a joint in a component, or more commonly, a proposed joint between two components. In the embodiment illustrated, the filler material 102 is positioned to be on top of the crack 12. The filler material 102 needs to be positioned such that when it melts, it migrates into the crack 12. In some instances, the migration may be accomplished through capillary forces. The filler material 102 may be a metal alloy alone, or it may be an amalgamation of a metal alloy and an optional binder material. The filler material may be formed of an alloy, and more particularly, a superalloy.

Specifically, the filler material may be formed from a conventional braze alloy, such as Ni-19Cr-10Si, AMS4782. Alternatively, the filler material may be formed of a high melting-point superalloy that is compatible with the base material. Typical examples that would be used in gas turbines include IN718, René N5, René N4, René 142, or René 80. While the aforementioned examples are all nickel-based, it should be appreciated that the crack repairing system 100 may be used in other alloy systems. Moreover, useful braze alloy materials and related technology are also described in U.S. Pat. NO. 7,651,023, issued to S-C Huang et al, and U.S. Patent Publication 2010/0193574 (Cretegny et al), both incorporated herein by reference.

The optional binder may be formed of a material that, when sufficiently heated, will volatilize. More specifically, the binder may be formed of a material that, if heated in a sufficiently low-pressure atmosphere, is capable of generating vapors at a localized pressure that is higher than the surrounding atmosphere. An example of a suitable binder is a water-based organic polymeric binder commercially available from the Vitta Corporation, and marketed as VITTA GEL®.

With continuing reference to FIG. 2, plasma generating material 104 is also located near the crack 12. (It should be appreciated that when a binder is used, it can serve as the plasma generating material 104). The plasma generating material 104 should be formed of materials that are highly susceptible to microwave radiation at room temperature. Examples of suitable plasma generating materials include various compounds based on Group IA elements, Group VIIB elements, or combinations thereof, that are solid at room temperature. Alkali metal halides and alkali metal hydroxides are illustrative. Non-limiting, specific examples of these materials include sodium hydroxide, sodium chloride, sodium bromide, potassium chloride, and potassium bromide.

As shown for the embodiment of FIG. 2, the filler material 102 and the plasma generating material 104 are sited within a first cover 106. The first cover 106 is sited over the crack 12, and within a vacuum chamber 95. Upon placing the first cover 106 over the crack 12, the seal between the first cover and the component is not vacuum-tight, and so an interior region or space 108 of the first cover is evacuated prior to starting the heating process.

The first cover 106 is preferably formed of a material that is substantially transparent to microwaves, e.g., allowing at least about 80% (and preferably, at least about 90%) of the microwave energy to pass through the cover at room temperature. The material will also be capable of enhancing the ability of the microwave radiation to heat the interior space 108 to a temperature high enough to volatilize the plasma generating material 104, and to melt the filler material 102, causing it to flow into crack 12. In some embodiments, the chamber cover 106 may be formed of one or more materials from the group consisting of oxides (e.g., alumina), borides, nitrides, carbides, or combinations thereof.

A variety of conventional microwave generators can be used for the present invention; and most are commercially available from a number of sources. Moreover, the generator can be incorporated into the overall repair system in a number of ways, by those of ordinary skill in the art. The microwave generator (not shown in the figures) is usually situated outside of the vacuum chamber, e.g., chamber 95 in FIG. 2. A waveguide connected to the generator can transmit microwaves through a suitable opening (not shown) in the vacuum chamber enclosure.

In operation, microwaves from a generated microwave field radiate through the vacuum chamber 95, and into the first cover 106, heating and vaporizing the plasma-generating material 104. The vaporization of the plasma generating material 104 creates a gas that can be ionized and ignited to form the plasma. The heat from the plasma is sufficient to melt the filler material 102, allowing the filler material 102 to migrate into the crack 12, leaving a melted filler material 103.

In some embodiments that include filler materials with high melting points, the plasma does not fully melt the filler material. In such cases, the plasma heats the first cover 106 to a temperature at which the cover begins to absorb microwave energy, and emits heat. The characteristic temperature at which this occurs is different for each cover material. The filler material 102 is then melted by conduction and/or radiation that is emitted from the ceramic first cover 106.

With particular reference to FIG. 4, there is shown another embodiment of a repair system 200. The repair system 200 includes a filler material 102 and a first cover 106. The first cover 106 usually includes an opening 210. Further, the first cover 106 is encased within a second cover 212. (In this embodiment, the first cover functions to heat the filler material, while the second cover functions to retain the plasma generated from the plasma-generating material).

The second cover 212 is formed of a material that is substantially transparent to microwaves (as that term is explained above). Moreover, the second cover 212 may be formed of a material that assists in creating a proper heating regime within the first cover 106. One example of a suitable material for the second cover 212 is quartz.

In the embodiment of FIG. 4, the plasma generating material 104 is located in the region or space 214 between the second cover 212 and the first cover 106. It should be appreciated, however, that the plasma generating material can be located anywhere inside the second cover 212. In fact, the plasma generating material can also be combined with the filler material to form a single material. In that instance, the presence of the separate material 104 may not be necessary. A vacuum chamber 95 that encloses repair system 200 exerts a vacuum over both covers 106 and 212, as well as the crack 12, the filler material 102, and the plasma generating material 104.

In operation, microwaves generated from the microwave field are directed through the vacuum chamber 95 to heat the plasma generating material 104 located within the cover 106 or 212, until it vaporizes. The vaporized atoms are allowed to migrate throughout the region 214, and enter the first cover 106 through the opening 210. Continued heating with microwaves eventually ignites the vaporized atoms, allowing melting of the filler material 102, so that it fills the crack 12.

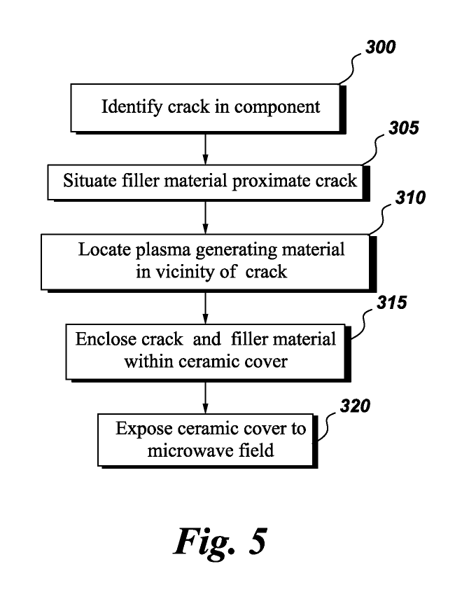

With specific reference to FIG. 5, and more general reference to FIGS. 2-4, there is shown a method for repairing a crack in a component of a gas turbine. At Step 300, a crack is identified in a component. The identification of the crack can be accomplished through a variety of known techniques, such as visual inspection.

Once the crack has been identified in terms of its location on the component, as well as its dimensions, at Step 305, a filler material is situated at a location proximate to the crack. By “proximate” is meant that upon melting, the filler material will readily migrate into the crack. The filler material may be, for example, the filler material 102.

Next, at Step 310, a plasma generating material, such as the plasma generating material 104, is located in the vicinity of the crack. The term “in the vicinity” is meant to describe a position within the region enclosed by the cover. The position should be near enough so that upon volatilization and ignition, the plasma generating material is enabled to generate sufficient heat to melt the filler material, while not detrimentally affecting the metallurgical integrity of the substrate, e.g., the gas turbine component.

In some preferred embodiments, the plasma-generating material is located on the inner surface of the cover situated over the crack, e.g., on the surface 107 of cover 106, depicted in FIG. 2. In the embodiment of FIG. 4, the location of the plasma generating material can also vary considerably, e.g., on the inner surface of cover 106 or cover 212.

At Step 315, a cover is placed around the crack and the filler material (i.e., over the crack and filler material, so as to surround them), as described previously. The plasma generating material may also be within the cover. The component, including the cover, is positioned within a vacuum chamber, which exerts a vacuum over the interior space surrounding the crack and the filler material. In one embodiment, there is an interior cover and an exterior cover, as set forth above. In that embodiment, one of the covers serves to retain the plasma, while the other cover serves to heat the filler material. Finally, at Step 320, the cover(s) is/are exposed to a microwave field, to fully carry out the repair process. (As those skilled in the art understand, the microwave field is actually generated throughout the vacuum chamber, i.e., chamber 95 in FIGS. 2 and 4, resulting in exposure of the cover(s) to the field).

### EXAMPLE

To determine the tensile strength of components repaired using embodiments of the invention, flat blanks, formed of either René™ N5 or IN718 nickel superalloys, were prepared with a 0.040 inch (1.02 mm) gap in the center for filling. The filler (powdered repair material) was Rene 142, a high-melting point, nickel-based superalloy material typically used in welding repairs. The filler was mixed with about 15-20% by weight Vitta® binder gel, a commercially-available organic-based product that also contained sodium hydroxide. The resulting mixture was placed in the vicinity of the gap to be filled, i.e., a few millimeters from the gap, and in some instances, directly on top of the gap.

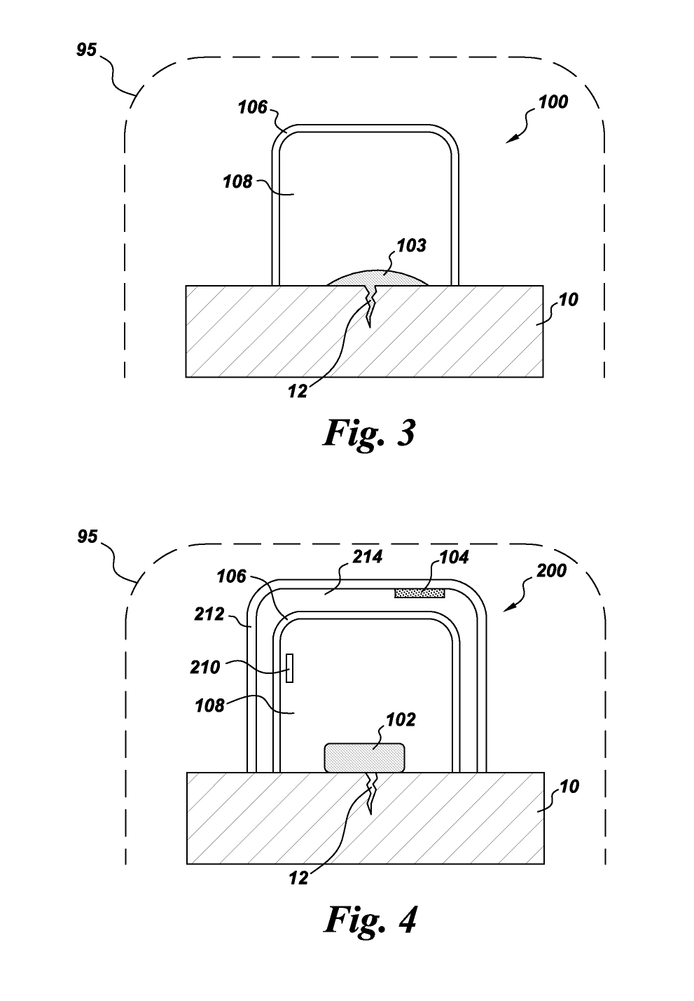

An alumina cover with a slot was then placed over the gap and filler, and a quartz cover was placed over the alumina cover. The repair system thus formed was similar to that of FIG. 4, differing mainly in that the plasma generating material was combined with the filler material, and not placed between the covers. The repair system was then placed in a vacuum microwave chamber, which was brought to a pressure of 4E-5 Torr. Microwave power was ramped up to 6 kW over 30 minutes, and then ramped back down, with plasma initially appearing between 1 and 2 kW. The alumina cover absorbed the microwaves and radiated heat at the higher microwave powers. The filled gap in the substrate was similar to that depicted in FIG. 3.

Table 1 below provides results of the various experiments, performed at a room temperature of 70° F. (21° C.). The results are provided as ultimate tensile strength (UTS) and tensile elongation (TE). UTS is the maximum stress that a material can withstand while being stretched or pulled before “necking”, which is when the specimen's cross-section starts to significantly contract. TE is the percentage increase in length that occurs before the material breaks under tension.

TABLE 1
Tensile tested at room temperature (70° F.) (21° C.)

| Repaired Substrates | UTS (ksi) | TE (%) |
|---|---|---|
| IN718-1 | 119 | 19 |
| IN718-2 | 109 | 12 |
| René N5-23 | 124 | 17 |
| René N5-1 | 128 | 14 |
| René N5-20 | 114 | 5 |
| René N5-2 | 105 | 0 |
| René N5-3 | 93 | 0 |
| René N5-16 | 72 | 0 |

The results of the experiments reported in Table 1 indicate that the two Inconer samples showed high ultimate tensile strength and tensile elongation. Further, two of the six René samples reported also showed high UTS and TE. Those two René samples, René N5-23 and René N5-1, however, ultimately failed (a typical end-point for such a test). The René N5-23 substrate failed in the base metal, while René N5-1 substrate failed at the joint. Such results indicate that the joint was as strong and ductile as the base metal.

It is thought that the remaining four René substrate-samples ultimately failed because of a lack of sufficient process control. For example, the samples may have contained porosity in the joints, and/or may have been filled with filler materials that were only partially melted. It is believed that performance-to-failure for all or most of these samples could be improved with continuous, routine process development by those of ordinary skill in the art, in combination with the inventive teachings set forth in this disclosure.

The foregoing description describes inventive embodiments in which gas turbine components or other high-temperature metallic parts can be repaired or otherwise treated by a local heating technique that utilizes microwaves. These heating techniques provide local heating to the immediate vicinity of the repair site (e.g., a crack) in the gas turbine component, thus limiting the thermal stress only to that already damaged location. Further, the local heating techniques exemplified in the embodiments of the invention allow for the use of alloy filler material that is more similar to the original material (e.g., a superalloy), thus allowing for a stronger repair or joint. For these reasons, improved methods of refurbishing turbine engine components or other high-temperature articles constitute part of the scope of these inventive concepts.

It should also be understood that, while crack repair has been illustrated in this disclosure, the process and system can be used for purposes other than repair. For example, the inventive embodiments can be employed to fill any type of cavity in a high-temperature component, and can also be used to join two components to each other. As a non-limiting illustration, two components could be situated very close to each other, in place of component 10 in FIG. 2, or being disposed on another suitable substrate within vacuum chamber 95. The spacing (i.e., “interface”) between the surfaces of the two components would be determined by those skilled in the brazing arts. (See the Huang patent referenced above, for example).

The joint-forming material (braze material) could be placed proximate to the interface, and the plasma-generating material could be disposed in the vicinity of the interface. A ceramic cover, as described above, would lie over the interface and enclose it, as generally depicted in FIG. 2. A microwave field could be generated within the enclosure region formed under the ceramic cover, providing microwave energy to ignite and sustain a plasma, as described previously. The plasma pre-heats the filler material; and the microwave energy is absorbed by the cover to increase the cover temperature, thereby completely melting the filler material, and causing it to flow into the interface. Cooling of the filler material causes it to solidify, forming the desired joint. A similar type of process could be carried out to form a joint, using the two-cover embodiment, as also described previously.

While the invention has been described in detail in connection to some embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Accordingly, the invention is not to be seen as limited by the foregoing description, but is only limited by the scope of the appended claims.

What is claimed is:

1. A system for repairing a crack in a component, or forming a joint between two components, wherein the system comprises:
a) filler material;
b) a plasma-generating material; and
c) a ceramic cover, wherein
the cover is positioned around the crack or around an interface region between two components that are to be joined;
the filler material is positioned proximate to the crack or the interface region; and
the plasma generating material is positioned in the vicinity of the crack or the interface region; and
d) a microwave generator for generating a microwave field inside an enclosure region enclosed by the cover, and proximate to the crack or interface region.

2. The system of claim 1, wherein the filler material comprises a superalloy.

3. The system of claim 1, wherein the plasma generating material is attached to an inner surface of the cover.

4. The system of claim 1, wherein the plasma generating material is a solid material at room temperature.

5. The system of claim 1, wherein the plasma-generating material comprises a Group IA element, a Group VIIB element, or combinations thereof.

6. The system of claim 5, wherein the plasma-generating material comprises at least one alkali metal halide compound, at least one alkali metal hydroxide, or combinations thereof.

7. The system of claim 1, wherein the filler material and the plasma-generating material are combined.

8. The system of claim 1, wherein the cover is formed of a material comprising oxides, borides, nitrides, carbides, or combinations thereof.

9. The system of claim 8, wherein the material forming the cover comprises alumina.

10. The system of claim 1, contained within a vacuum chamber.

11. The system of claim 1, wherein a second cover is disposed over, and encloses, the ceramic cover (“first cover”).

12. The system of claim 11, wherein the plasma-generating material is located between the first cover and the second cover; or within the enclosure region of the first cover.

13. The system of claim 11, wherein the first cover contains at least one opening that communicates with a region enclosed by the second cover.

14. A method for filling at least one cavity in a metallic component, comprising the steps of:
(i) disposing a filler material proximate to the cavity;
(ii) situating a plasma-generating material in the vicinity of the cavity;
(iii) providing a ceramic cover over the cavity in the component, so as to form an enclosure region under the cover; and
(iv) generating a microwave field within the enclosure region that provides microwave energy to ignite and sustain a plasma, wherein the plasma pre-heats the filler material; and wherein the microwave energy is absorbed by the cover to increase the cover temperature, thereby completely melting the filler material, and causing it to flow into the cavity.

15. The method of claim 14, wherein the cavity is a crack in the casting component, and the crack is repaired by the flow of filler material therein, according to step (iv).

16. The method of claim 14, wherein the filler material comprises a superalloy material; and the plasma-generating material comprises a Group IA element, a Group VIIB elements, or combinations thereof.

17. The method of claim 14, comprising enclosing the cover within a second cover.

18. The method of claim 17, wherein the plasma-generating material is located between the ceramic cover and the second cover; or within the enclosure region of the first ceramic cover.

19. A method of refurbishing a turbine engine, comprising the following steps:
(I) identifying a crack or joint in a component of the turbine engine;
(II) situating a filler material proximate to the crack or joint;
(III) disposing a plasma-generating material in the vicinity of the crack or joint, separate from the filler material, or combined therewith;
(IV) enclosing the crack or joint and filler material within a ceramic cover; and
(V) exposing the cover to a microwave field, wherein the microwave field ignites and sustains a plasma for preheating the filler material and the cover; and wherein microwave energy absorbed by the cover melts the filler material into the crack or joint.

20. A method for joining two metal components, comprising the following steps:
(A) disposing a joint-forming filler material proximate to an interface between the two components;
(B) situating a plasma-generating material in the vicinity of the interface;
(C) providing a ceramic cover over the interface between the components, so as to form an enclosure region under the cover; and
(D) generating a microwave field within the enclosure region that provides microwave energy to ignite and sustain a plasma, wherein the plasma pre-heats the filler material; and wherein the microwave energy is absorbed by the cover to increase the cover temperature, thereby completely melting the filler material, and causing it to flow into the interface.
